(19) United States
(12) Patent Application Publication
(10) Pub. No.: US 2023/0185644 A1
(43) Pub. Date: Jun. 15, 2023

(54) INTEGRATING ACCESS TO MULTIPLE SOFTWARE APPLICATIONS

(71) Applicant: SAP SE, Walldorf (DE)

(72) Inventors: Nikolas Werner, Sandhausen (DE); Jeffrey Ingram, Purcellville, VA (US)

(21) Appl. No.: 17/546,457

(22) Filed: Dec. 9, 2021

(51) Int. Cl. G06F 9/54; G06F 16/27; G06F 9/451

(52) U.S. Cl. CPC G06F 9/547; G06F 16/27; G06F 9/451

(57) ABSTRACT

A method for providing integrated access to multiple software applications may include detecting, by a plug-in associated with a browser at a client device, one or more interactions with a first data record associated with a first software application. One or more identifiers associated with the first data record may be identified such that a second data record associated with a second software application may be identified based on the one or more identifiers. Access to at least the second data record associated with the second software application may be provided at the client device. For example, the plug-in may display the second data record at the client device or provide a deep link to access the second data record through the second software application. Related systems and computer program products are also provided.

### TECHNICAL FIELD

The subject matter described herein relates generally to data processing and more specifically to providing integrated access to multiple proprietary and third-party software applications.

### BACKGROUND

An enterprise may rely on a suite of enterprise software applications for sourcing, procurement, supply chain management, invoicing, and payment. These enterprise software applications may provide a variety of data processing functionalities including, for example, billing, invoicing, procurement, payroll, time and attendance management, recruiting and onboarding, learning and development, performance and compensation, workforce planning, and/or the like. Examples of enterprise software applications may include enterprise resource planning (ERP) software, customer relationship management (CRM) software, and/or the like. Data associated with multiple enterprise software applications may be stored in a common database in order to enable integration across different enterprise software applications. Moreover, to provide access to multiple end users from different geographic locations, many enterprise software applications may be deployed as a web-based application and/or a cloud-based application such that the functionalities of the enterprise software applications are available for remote access.

### SUMMARY

Systems, methods, and articles of manufacture, including computer program products, are provided for integrating access across multiple software applications. In some example embodiments, there is provided a system that includes at least one processor and at least one memory. The at least one memory may include program code that provides operations when executed by the at least one processor. The operations may include: detecting, at a client device, one or more interactions with a first data record associated with a first software application; determining one or more identifiers associated with the first data record; identifying, based at least on the one or more identifiers, at least a second data record associated with a second software application; and providing, at the client device, access to at least the second data record associated with the second software application.

In some variations, one or more features disclosed herein including the following features can optionally be included in any feasible combination. The access to at least the second data record may be provided by displaying, at the client device, the second data record.

In some variations, the access to at least the second data record may be provided by providing a link to access the second data record through the second software application.

In some variations, the access to at least the second data record may be provided through one or more application programming interface (API) calls to identify and/or retrieve the second data record from the second software application.

In some variations, the operations may further include: generating, for display as an overlay on top of a user interface associated with the first software application, a user interface element for performing an action on the first data record at the second software application.

In some variations, the action may include editing the first data record at the second software application. In response to a selection of the user interface element, one or more changes made to the first data record through the first software application may be replicated to the second data record at the second software application.

In some variations, the client device may include a plug-in configured to detect the one or more interactions with the first data record.

In some variations, the plug-in may determine the one or more identifiers associated with the first data record by at least parsing a current universal resource locator (URL) of an active window and/or tab of the browser.

In some variations, the plug-in may include a software add-on to a browser at the client device. The first software application and the second software application may include cloud-based applications and/or web-based applications accessible through the browser at the client device.

In some variations, the access to at least the second data record may be provided upon performing an authentication of a user at the client device.

In some variations, the one or more identifiers may include a customer identifier and/or an account identifier.

In some variations, the first software application and the second software application may include one or more of an enterprise resource planning (ERP) application, a customer relationship management (CRM) application, a process management application, a process intelligence application, a sales engagement application, a territory and quota management application, an agent performance management (APM) application, a social networking application, or a data warehousing application.

In another aspect, there is provided a method for integrating access across multiple software applications. The method may include: detecting, at a client device, one or more interactions with a first data record associated with a first software application; determining one or more identifiers associated with the first data record; identifying, based at least on the one or more identifiers, at least a second data record associated with a second software application; and providing, at the client device, access to at least the second data record associated with the second software application.

In some variations, one or more features disclosed herein including the following features can optionally be included in any feasible combination. The access to at least the second data record may be provided by displaying, at the client device, the second data record.

In some variations, the access to at least the second data record may be provided by providing a link to access the second data record through the second software application.

In some variations, the access to at least the second data record may be provided through one or more application programming interface (API) calls to identify and/or retrieve the second data record from the second software application.

In some variations, the method may further include: generating, for display as an overlay on top of a user interface associated with the first software application, a user interface element for performing an action on the first data record at the second software application, the action comprising editing the first data record at the second software application, and one or more changes made to the first data record through the first software application being replicated to the second data record at the second software application in response to a selection of the user interface element.

In some variations, the client device may include a plug-in configured to detect the one or more interactions with the first data record.

In some variations, the plug-in may determine the one or more identifiers associated with the first data record by at least parsing a current universal resource locator (URL) of an active window and/or tab of the browser.

In another aspect, there is provided a computer program product including a non-transitory computer readable medium storing instructions. The instructions may cause operations may executed by at least one data processor. The operations may include: detecting, at a client device, one or more interactions with a first data record associated with a first software application; determining one or more identifiers associated with the first data record; identifying, based at least on the one or more identifiers, at least a second data record associated with a second software application; and providing, at the client device, access to at least the second data record associated with the second software application.

Implementations of the current subject matter can include methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes, it should be readily understood that such features are not intended to be limiting. The claims that follow this disclosure are intended to define the scope of the protected subject matter.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 depicts a system diagram illustrating an example of an application delivery system, in accordance with some example embodiments;

FIG. 2 depicts a data flow diagram illustrating an example of a process for deploying a plug-in, in accordance with some example embodiments;

FIG. 3A depicts a flowchart illustrating an example of a process for integrated access across multiple software applications, in accordance with some example embodiments;

FIG. 3B depicts a flowchart illustrating another example of a process for integrated access across multiple software applications, in accordance with some example embodiments;

FIG. 3C depicts a flowchart illustrating another example of a process for integrated access across multiple software applications, in accordance with some example embodiments;

FIG. 3D depicts a flowchart illustrating another example of a process for integrated access across multiple software applications, in accordance with some example embodiments;

FIG. 3E depicts a flowchart illustrating another example of a process for integrated access across multiple software applications, in accordance with some example embodiments;

FIG. 3F depicts a flowchart illustrating another example of a process for integrated access across multiple software applications, in accordance with some example embodiments;

FIG. 3G depicts a flowchart illustrating another example of a process for integrated access across multiple software applications, in accordance with some example embodiments;

FIG. 3H depicts a flowchart illustrating another example of a process for integrated access across multiple software applications, in accordance with some example embodiments;

FIG. 3I depicts a flowchart illustrating another example of a process for integrated access across multiple software applications, in accordance with some example embodiments;

FIG. 3J depicts a screenshot illustrating an example of a user interface, in accordance with some example embodiments;

FIG. 4 depicts a flowchart illustrating an example of a process for providing integrated access across multiple software applications, in accordance with some example embodiments;

FIG. 5 depicts a block diagram illustrating an example of a computing system, in accordance with some example embodiments; and

When practical, similar reference numbers denote similar structures, features, or elements.

### DETAILED DESCRIPTION

Enterprise software applications may provide a variety of solutions for sourcing, procurement, supply chain management, invoicing, and payment. A typical enterprise workflow may involve numerous software applications, some of which may be developed in-house while others may originate from third-party vendors. Navigating across multiple software applications may be a convoluted task at least because of differences in the user interfaces associated with each software application. For example, a single enterprise workflow may require interaction with several different user interfaces in order to invoke the same or similar functionalities across multiple software applications. In some cases, unfamiliarity with the user interface of a software application may cause the misuse and/or underuse of at least some of the available functionalities. The resulting inefficiencies may diminish user experience and give rise to significant loss in enterprise productivity. As such, in some example embodiments, an integration controller may be configured to provide, through a plug-in deployed at a client device, integrated access to multiple software applications. In doing so, the integrated controller may deliver a consistent and cohesive user experience across multiple software applications, including software applications developed in-house and software applications developed by third-party vendors.

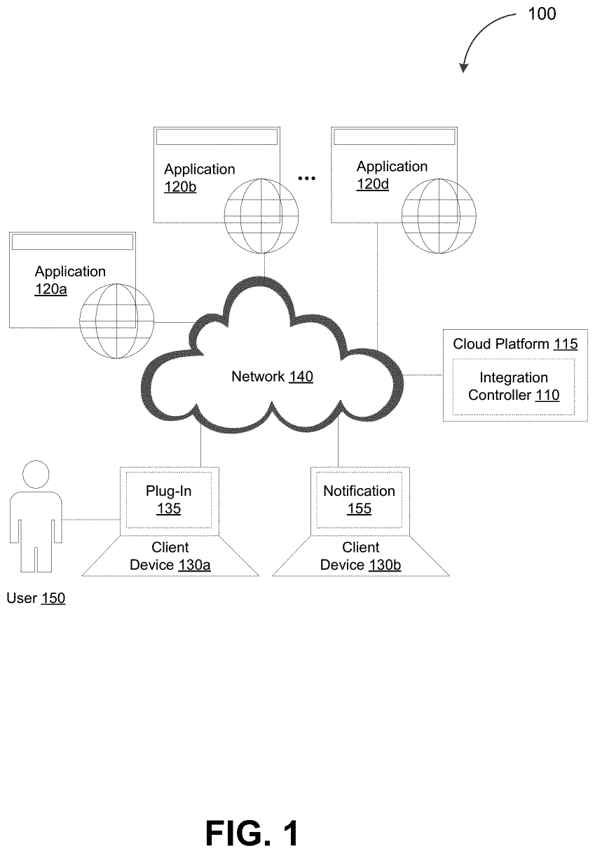

FIG. 1 depicts a system diagram illustrating an example of an application delivery system 100, in accordance with some example embodiments. Referring to FIG. 1, the application delivery system 100 may include an integration controller 110 hosted at a cloud platform 115, one or more software applications 120, and one or more client devices 130. The integration controller 110 at the cloud platform 115, the one or more software applications 120, and the one or more client devices 130 may be communicatively coupled via a network 140. The one or more client devices 130 may include processor-based devices including, for example, a smartphone, a tablet computer, a wearable apparatus, a virtual assistant, an Internet-of-Things (IoT) appliance, and/or the like. The one or more software applications 120 may be web-based applications and/or cloud-based applications accessible at the one or more client devices 130 through the network 140. For example, the one or more software applications 120 may be enterprise software applications such as enterprise resource planning (ERP) application, customer relationship management (CRM) application, process management application, process intelligence application, sales engagement application, territory and quota management application, agent performance management (APM) application, social networking application, and data warehousing application. The network 140 may be a wired network and/or a wireless network including, for example, a wide area network (WAN), a local area network (LAN), a virtual local area network (VLAN), a public land mobile network (PLMN), the Internet, and/or the like.

Referring again to FIG. 1, the integration controller 110 may be configured to provide, through a plug-in 135 at the first client device 130a, integrated access to the one or more software applications 120 including, for example, a first software application 120a, a second software application 120b, a third software application 120c, a fourth software application 120d, and/or the like. Each of the first software application 120a, the second software application 120b, the third software application 120c, and the fourth software application 120d may be associated with different user interfaces. Although the first software application 120a, the second software application 120b, the third software application 120c, and the fourth software application 120d may share and/or access common data objects, at least some information are not available across all of the one or more software applications 120. Nevertheless, through the plug-in 135 at the first client device 130a, the integration controller 110 may deliver a consistent and cohesive user experience across the first software application 120a, the second software application 120b, the third software application 120c, and the fourth software application 120d. For example, in response to a user 150 at a first client device 130a interacting with the first software application 120a, the plug-in 135 may interact with the integration controller 110 in order to deliver, to the first client device 130a, contextually relevant data from one or more of the second software application 120b, the third software application 120c, and the fourth software application 120d.

In some example embodiments, the plug-in 135 may be a software add-on to a browser at the first client device 130. Accordingly, the plug-in 135 may interact with the integration controller 110 to retrieve the contextually relevant data from one or more of the second software application 120b, the third software application 120c, and the fourth software application 120d when the user 150 interacts with the first software application 120a through the browser. For example, the interaction between the user 150 and the first software application 120a may be associated with one or more identifiers such as an account identifier, a customer identifier, and/or the like. As such, contextually relevant data may be retrieved from one or more of the second software application 120b, the third software application 120c, and the fourth software application 120d based on the one or more identifiers. In some instances, the one or more identifiers may be parsed by the plug-in 135 from the current universal resource locator (URL) of the active browser window and/or tab before being used as an input parameter to the account search. For instance, the integration controller 110 may collect the contextually relevant data through one or more application programming interface (API) calls to the second software application 120b, the third software application 120c, and/or the fourth software application 120d. Authentication of the user 150, which may be required to access the contextually relevant data, may be handled by the integration controller 110 and thus remain transparent to the user 150.

In some example embodiments, the plug-in 135 may be configured to deliver the contextually relevant data by displaying, for example, in a window at the first client device 130a, at least a portion of the contextually relevant data. Alternatively and/or additionally, the plug-in 135 may deliver the contextually relevant data by providing a corresponding link such as, for example, a deep link to access the contextually relevant data through the one or more of the second software application 120b, the third software application 120c, and the fourth software application 120d.

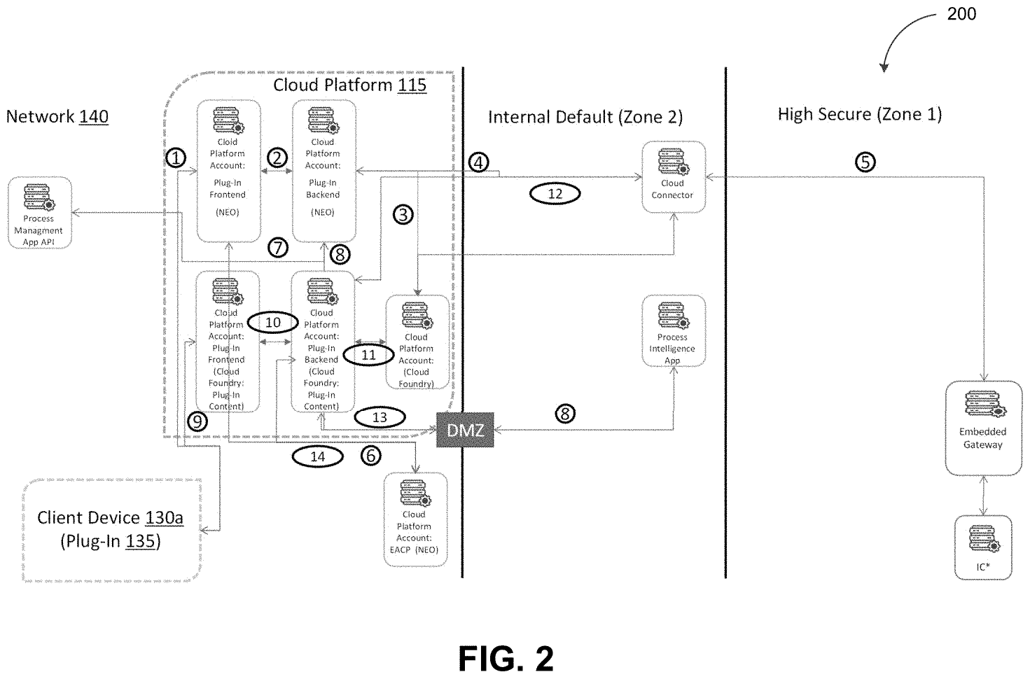

FIG. 2 depicts a data flow diagram illustrating an example of a process 200 for deploying the plug-in 135, in accordance with some example embodiments. In some example embodiments, upon installing the plug-in 135 at the first client device 130a, the plug-in 135 may be provided access to a local storage at the first client device 130a and a current browser window (or tab) at the first client device 130a. As noted, the plug-in 135 may then parse the universal resource locator (URL) associated with the current browser window (or tab) for use as an input parameter in subsequent searches for contextually relevant data. According to some example embodiments, the initial window the plug-in 135 opens, for example, at the first client device 130a, may be a user interface (UI) application hosted in a first environment (e.g. NEO) in the cloud platform 115 (1). This user interface application may make subsequent internal calls to two applications (2 & 3) hosted in a second environment (e.g., Cloud Foundry) in the cloud platform 115 in order to collect additional data and offer functionalities to the user 150. Calls may also be made to a cloud connector (4).

Referring again to FIG. 2, a backend application associated with the plug-in 135 (2) may make calls to the one or more applications 120 (5 & 6) in order to retrieve contextually relevant data for the user 150 at the first client device 130a. The user interface (UI) application hosted in the first environment (e.g., NEO) of the cloud platform 115 may provide a chat service (e.g., a chatbot). In order for the backend application of the plug-in 135 to translate any identifier to an identifier associated with the cloud platform 110, a connection to a corresponding cloud platform account (9) may be established. In some instances, the plug-in 135 may be a window around a website as per the plug-in standards of the corresponding browser. The content delivered by the plug-in 135, for example, to the first client device 130a, may therefore behave like a website, thus ensuring that the user 150 may be correctly authenticated via an Extensible Markup Language (XML) based authentication protocol such as security assertion markup language (SAML). The respective connections to the second environment (e.g., Cloud Foundry) within the cloud platform 115 may be temporary. Upon an initial loading of the plug-in 135, the plug-in 135 may be granted access to the one or more applications 120 (or a corresponding suite of applications) in order to enable integration with the one or more applications 120. This permission may be based on a token that is stored (e.g., by the corresponding services) and renewed on a periodic basis (e.g., every 90 days).

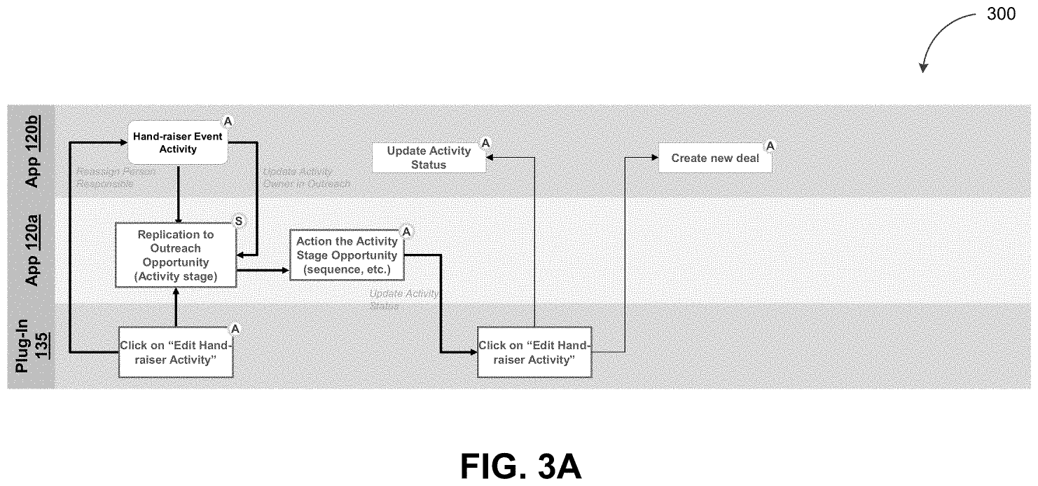

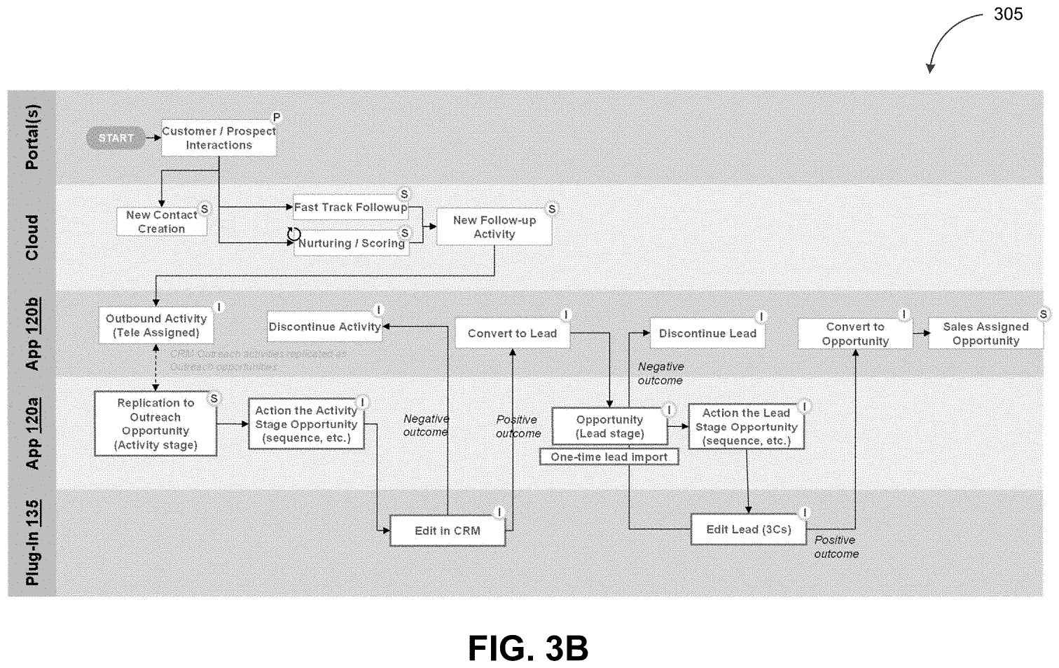

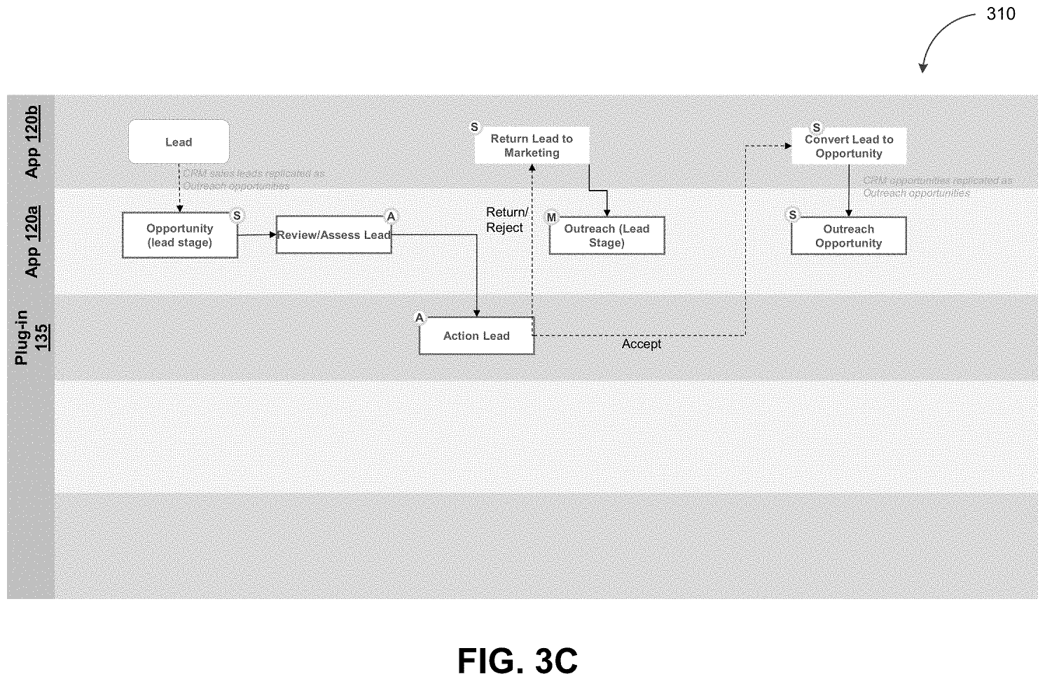

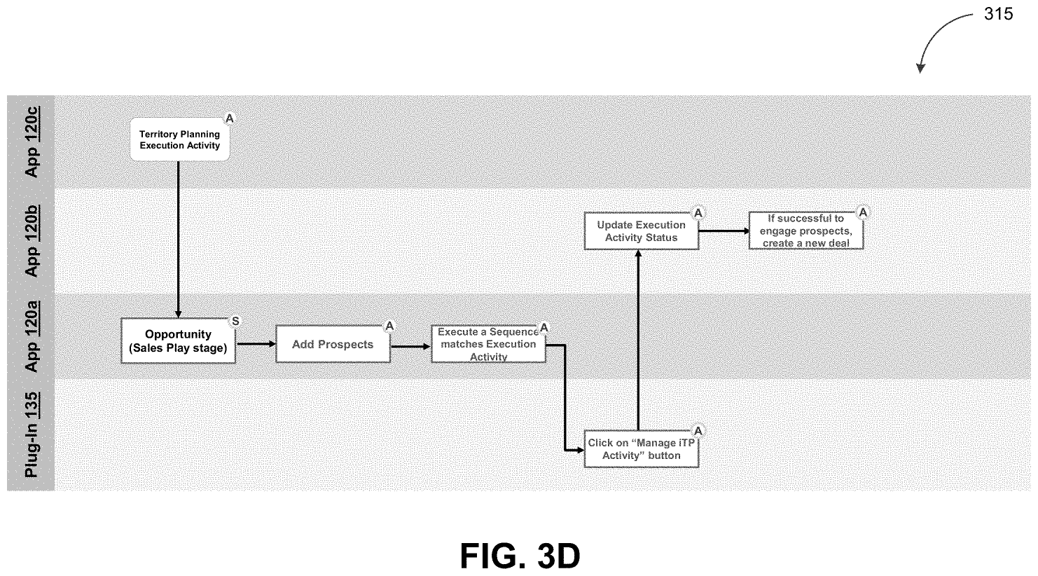

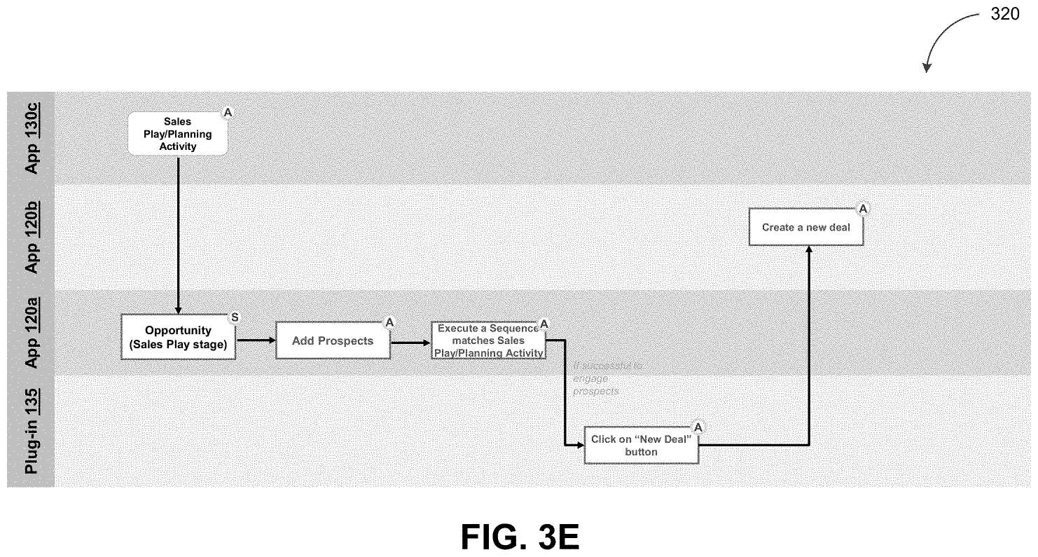

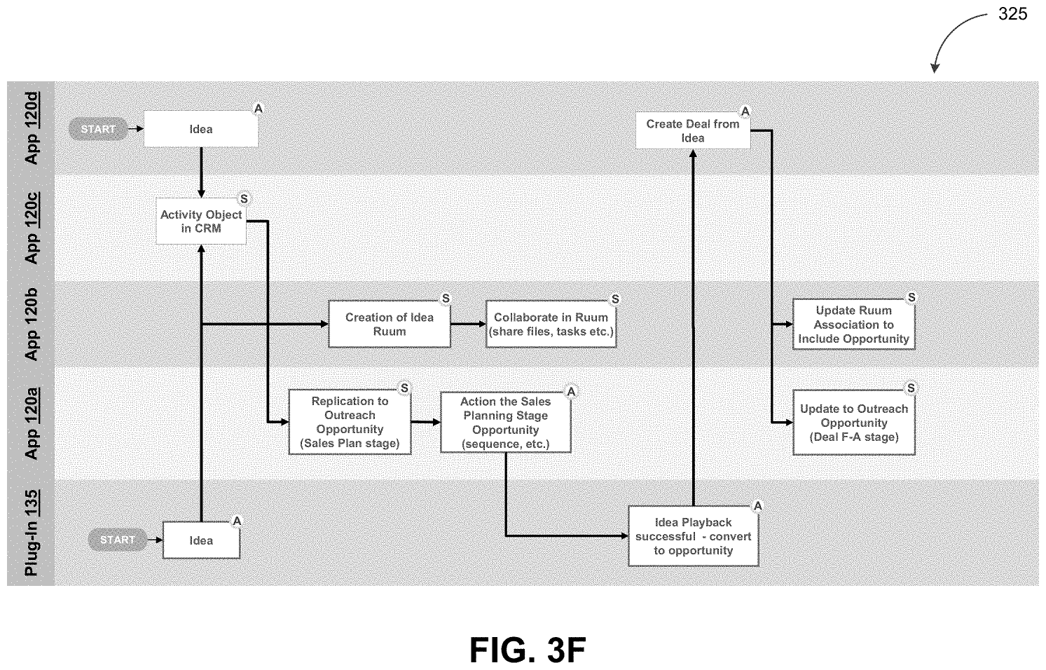

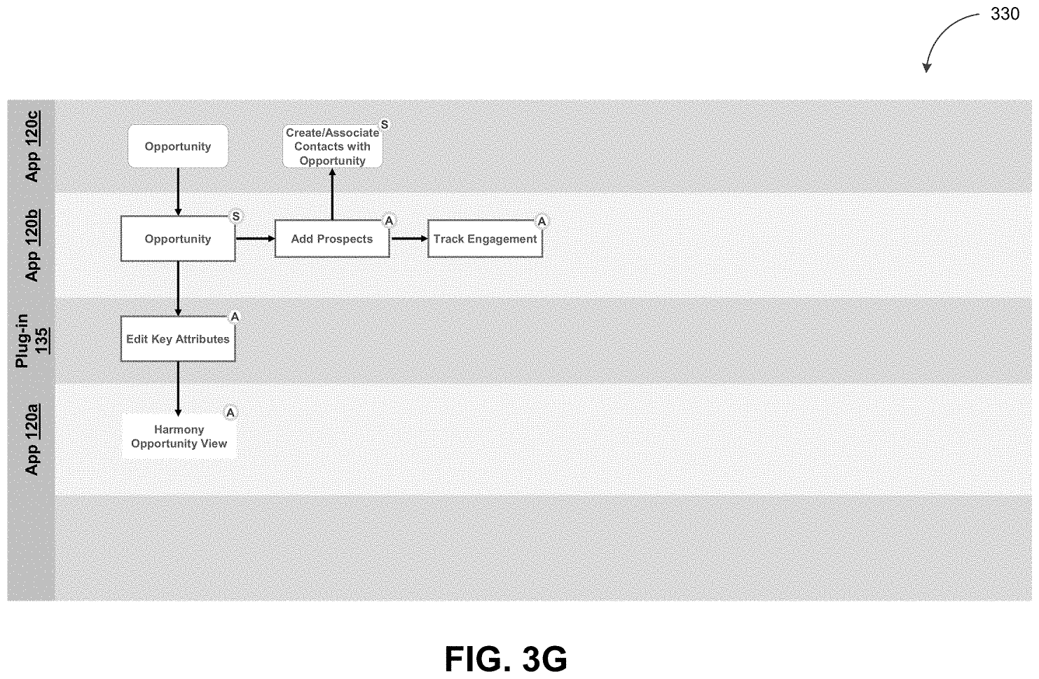

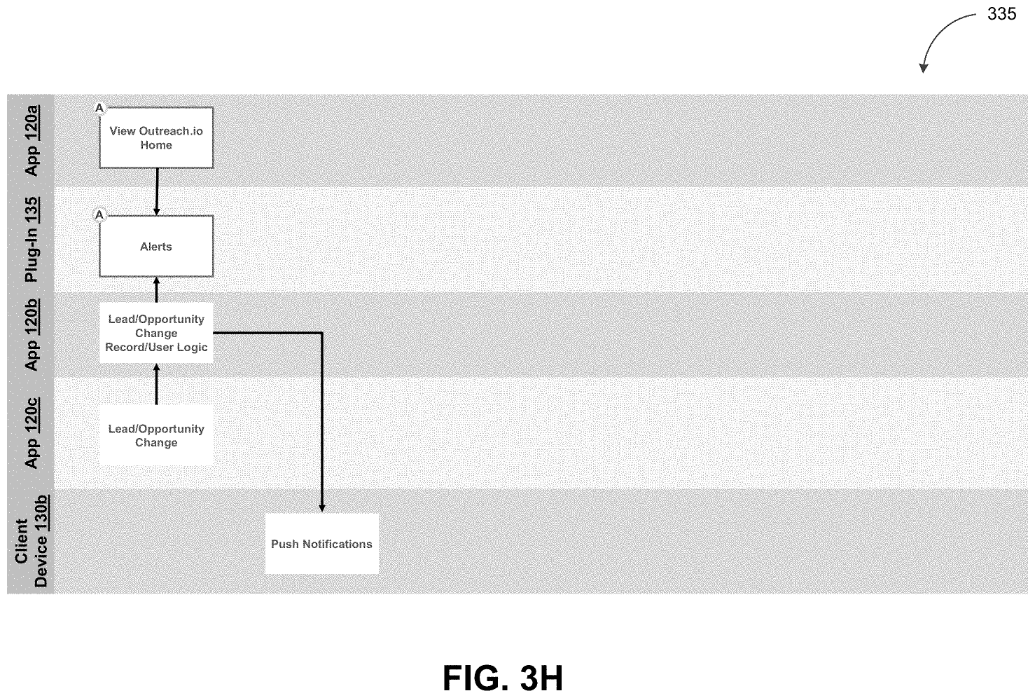

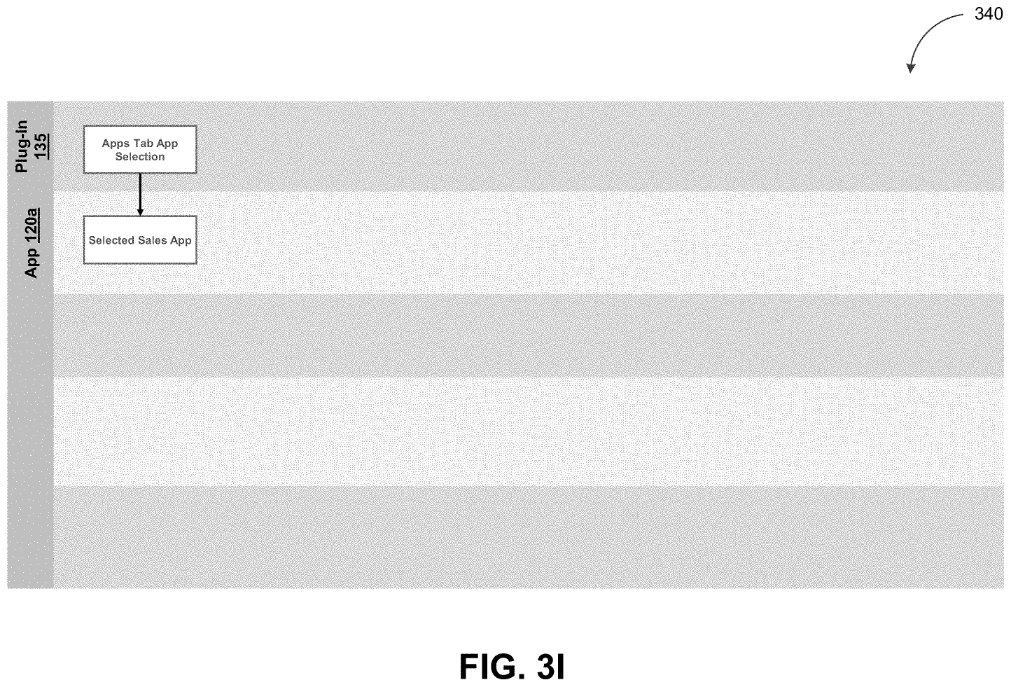

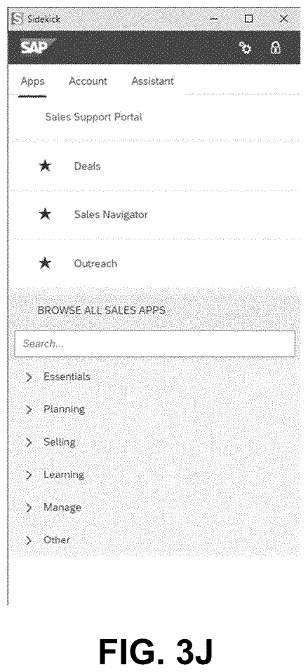

FIGS. 3A-J depict examples of use cases associated with the plug-in 135. For example, FIG. 3A depicts an example of a process 300 for integrated access across multiple software applications in which one or more actions (e.g., edit hand-raiser activity) taken at the first software application 120a (e.g., a sales engagement application) are routed to the second software application 120b (e.g., a customer relationship management (CRM) application). For example, as shown in FIG. 3A, the user 150 at the first client device 130a may interact with the first software application 120a to perform the action “edit hand-raiser activity.” In some instances, the plug-in 135 may generate, for display as an overlay on top of a user interface of the first software application 120a, one or more user interface elements for selecting the action “edit hand-raiser activity” (e.g., an “Edit Hand-raiser Activity” button). Upon detecting the user 150 performing the action “edit hand-raiser activity,” the plug-in 135 may propagate, to the second software application 120b, the changes made to the hand-raiser activity via the first software application 120a (e.g., reassigning the hand-raiser activity to a new owner).

FIG. 3B depicts a flowchart illustrating another example of a process 305 for integrated access across multiple software applications, in accordance with some example embodiments. In the example of the process 305 shown in FIG. 3B, the user 150 may initiate a customer interaction and/or a prospect interaction through a portal. Doing so may trigger the creation of a new contact (or lead) in a data store such as a cloud-based repository. Moreover, in response to subsequent actions at the first software application 120a (e.g., a sales engagement application) that modify the contact (or lead), such as “discontinue activity,” “covert to lead,” “discontinue lead,” and “convert to opportunity,” the plug-in 135 may replicate the changes to the second software application 120b (e.g., a customer relationship management (CRM) application). For example, in some instances, the plug-in 135 may generate, for display as an overlay on top of a user interface of the first software application 120a, one or more user interface elements to trigger the propagation of the changes made in the first software application 120a to the second software application 120b (e.g., an “Edit in CRM” button).

FIG. 3C depicts a flowchart illustrating another example of a process 310 for integrated access across multiple software applications, in accordance with some example embodiments. In the example of the process 310 shown in FIG. 3C, the plug-in 135 may replicate a first data (e.g., “leads”) from the second software application 120b (e.g., customer relationship management (CRM) application) as a second data (e.g., “opportunities”) at the first software application 120a (e.g., sales engagement application). The plug-in 135 may generate, for display as an overlay on top of a user interface of the first software application 120a, one or more user interface elements for performing an action on the first data associated with the second software application 120b.

FIG. 3D depicts a flowchart illustrating another example of a process 315 for integrated access across multiple software applications, in accordance with some example embodiments. In the example of the process 315 shown in FIG. 3D, the plug-in 135 may replicate a third data (e.g., “territory planning execution activity”) from the third software application 120c (e.g., a territory and quota management application) as the second data (e.g., “opportunities”) at the first software application 120a (e.g., a sales engagement application). In the example of the process 320 shown in FIG. 3E, a fourth data (e.g., “sales play/planning activity”) from the third software application 120c (e.g., a territory and quota management application) may be replicated as the second data (e.g., “opportunities”) at the first software application 120a (e.g., a sales engagement application).

FIG. 3F depicts a flowchart illustrating another example of a process 325 for integrated access across multiple software applications, in accordance with some example embodiments. Referring to FIG. 3E, in some example embodiments, the plug-in 135 may support the flow of data through the first software application 120a (e.g., a sales engagement application), the second software application 120b (e.g., a process management application), the third software application 120c (e.g., a customer relationship management (CRM) application), and the fourth software application 120d (e.g., an agent performance management (APM) application). For example, a first data (e.g., an “account planning idea”) created within the plug-in 135 may will flow into a workspace within the first software application 120a (e.g., a sales engagement application) as a second data (e.g., a “sales plan stage opportunity”). Within the first software application 120a, the user 150 may interact with the second data including by, for example, identifying key contacts, initiating engagement activities, create new account planning ideas, and/or the like. Moreover, the user 150 may create process management objects at the second software application 120b (e.g., a process management application) for the data created within the plug-in 135 and the first software application 120a.

FIG. 3G depicts a flowchart illustrating another example of a process 330 for integrated access across multiple software applications, in accordance with some example embodiments. In the example of the process 330 shown in FIG. 3G, the plug-in 135 may generate, for display as a first overlay on top of a first user interface of the second software application 120a (e.g., a sales engagement application), one or more user interface elements for editing a first data associated with the third software application 120b (e.g., a customer relationship management (CRM) application). Moreover, the plug-in 135 may also generate, for display as a second overlay on top of a second user interface of the third software application 120c (e.g., a customer relationship management (CRM) application), one or more user interface elements for editing a second data associated with the second software application 120b. In some cases, the first data associated with the third software application 120c may be updated based on the second data associated with the second software application 120b. Likewise, the second data associated with the second software application 120b may also be updated based on the first data associated with the third software application 120c. As shown in FIG. 3G, at least a portion the first data associated with the third software application 120c (e.g., a customer relationship management (CRM) application) and the second data associated with the second software application 120b (e.g., a sales engagement application) may be imported for display in the first software application 120a (e.g., a social network application).

FIG. 3H depicts a flowchart illustrating another example of a process 335 for integrated access across multiple software applications, in accordance with some example embodiments. As shown in FIG. 3H, the plug-in 135 may provide alerts in response to data changes (e.g., “lead/opportunity change”) at the second software application 120b (e.g., a data warehousing application) and/or the third software application 120c (e.g., a customer relationship management (CRM) application). The alert may be displayed in the plug-in 135 while being accessible from the first software application 120a (e.g., a sales engagement application). Moreover, as shown in FIG. 3H, the second software application 120b may provide, for example, to the second client device 130b, a notification 155 (e.g., a push notification) corresponding to the data changes at the second software application 120b.

FIG. 3I depicts a flowchart illustrating another example of a process 340 for integrated access across multiple software applications, in accordance with some example embodiments. Referring to FIG. 3I, in some example embodiments, one or more of the first software application 120a, the second software application 120b, the third software application 120c, and the fourth software application 120d may be accessible from the plug-in 135. For example, as shown in FIG. 3J, the plug-in 135 may include an “Apps” tab that contains a listing of the first software application 120a, the second software application 120b, the third software application 120c, and the fourth software application 120d. As such, one or more of the first software application 120a, the second software application 120b, the third software application 120c, and the fourth software application 120d may be accessed by selecting a corresponding item under the “Apps” tab within the plug-in 135.

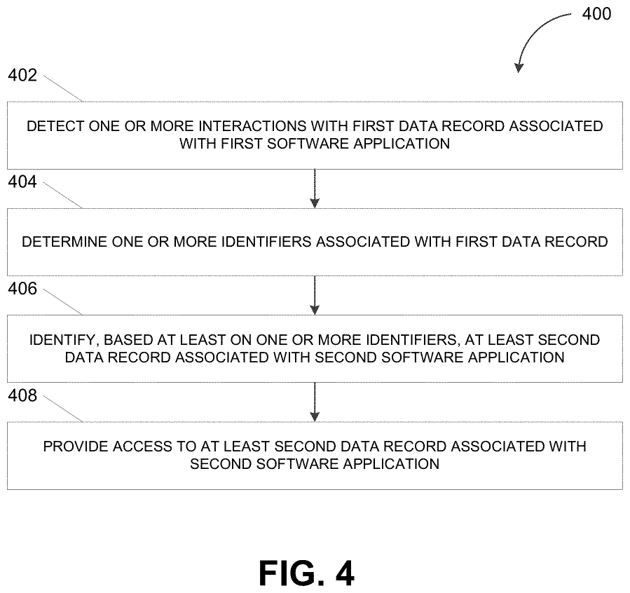

FIG. 4 depicts a flowchart illustrating an example of a process 400 for providing integrated access across multiple software applications, in accordance with some example embodiments. Referring to FIGS. 1-4, the process 400 may be performed by the integration controller 110 and the corresponding plug-in 135 in order to deliver a consistent and cohesive user experience across multiple software applications including, for example, the first software application 120a, the second software application 120b, the third software application 120c, the fourth software application 120d, and/or the like.

At 402, the integration controller 110 may detect one or more interaction with a first data record associated with a first software application. For example, the user 150 at the first client device 130a may interact with a first data record though the first software application 120a. The first software application 120a may be a web-based application and/or a cloud-based application. Meanwhile, the plug-in 135 may be a software add-on to a browser at the first client device 130. Accordingly, the plug-in 135 may detect when the user 150 is interacting with the first data record while the user 150 interacts with the first software application 120a through the browser.

At 404, the integration controller 110 may determine one or more identifiers associated with the first data record. For example, the first data record may be associated with one or more identifiers such as an account identifier, a customer identifier, and/or the like. These identifiers may be associated with the same (or same type) of data records at one or more other software applications such as the second software application 120b, the third software application 120c, and the fourth software application 120d.

At 406, the integration controller 110 may identify, based at least on the one or more identifiers, at least a second data record associated with a second software application. In some example embodiments, the plug-in 135 may interact with the integration controller 110 to retrieve the contextually relevant data from one or more of the second software application 120b, the third software application 120c, and the fourth software application 120d when the user 150 interacts with the first software application 120a through the browser. For example, contextually relevant data may be retrieved from one or more of the second software application 120b, the third software application 120c, and the fourth software application 120d based on the one or more identifiers. In some instances, the one or more identifiers may be parsed by the plug-in 135 from the current universal resource locator (URL) of the active browser window and/or tab before being used as an input parameter to the account search. Accordingly, the integration controller 110 may collect the contextually relevant data through one or more application programming interface (API) calls to the second software application 120b, the third software application 120c, and/or the fourth software application 120d.

At 408, the integration controller 110 may provide access to at least the second data record associated with the second software application. For example, in some example embodiments, the plug-in 135 may be configured to deliver the contextually relevant data by displaying, for example, in a window at the first client device 130a, at least a portion of the contextually relevant data. Alternatively and/or additionally, the plug-in 135 may deliver the contextually relevant data by providing a corresponding link such as, for example, a deep link to access the contextually relevant data through the one or more of the second software application 120b, the third software application 120c, and the fourth software application 120d.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application:

Example 1: A system, comprising: at least one data processor; and at least one memory storing instructions, which when executed by the at least one data processor, result in operations comprising: detecting, at a client device, one or more interactions with a first data record associated with a first software application; determining one or more identifiers associated with the first data record; identifying, based at least on the one or more identifiers, at least a second data record associated with a second software application; and providing, at the client device, access to at least the second data record associated with the second software application.

Example 2: The system of example 1, wherein the access to at least the second data record is provided by displaying, at the client device, the second data record.

Example 3: The system of any one of examples 1 to 2, wherein the access to at least the second data record is provided by providing a link to access the second data record through the second software application.

Example 4: The system of any one of examples 1 to 3, wherein the access to at least the second data record is provided through one or more application programming interface (API) calls to identify and/or retrieve the second data record from the second software application.

Example 5: The system of any one of examples 1 to 4, wherein the operations further include: generating, for display as an overlay on top of a user interface associated with the first software application, a user interface element for performing an action on the first data record at the second software application.

Example 6: The system of example 5, wherein the action comprises editing the first data record at the second software application, and wherein in response to a selection of the user interface element, one or more changes made to the first data record through the first software application are replicated to the second data record at the second software application.

Example 7: The system of any one of examples 1 to 6, wherein the client device includes a plug-in configured to detect the one or more interactions with the first data record.

Example 8: The system of example 7, wherein the plug-in determines the one or more identifiers associated with the first data record by at least parsing a current universal resource locator (URL) of an active window and/or tab of the browser.

Example 9: The system of any one of examples 7 to 8, wherein the plug-in comprises a software add-on to a browser at the client device, and wherein the first software application and the second software application comprise cloud-based applications and/or web-based applications accessible through the browser at the client device.

Example 10: The system of any one of examples 1 to 9, wherein access to at least the second data record is provided upon performing an authentication of a user at the client device.

Example 11: The system of any one of examples 1 to 10, wherein the one or more identifiers comprise a customer identifier and/or an account identifier.

Example 12: The system of any one of examples 1 to 11, wherein the first software application and the second software application comprise one or more of an enterprise resource planning (ERP) application, a customer relationship management (CRM) application, a process management application, a process intelligence application, a sales engagement application, a territory and quota management application, an agent performance management (APM) application, a social networking application, or a data warehousing application.

Example 13: A computer-implemented method, comprising: detecting, at a client device, one or more interactions with a first data record associated with a first software application; determining one or more identifiers associated with the first data record; identifying, based at least on the one or more identifiers, at least a second data record associated with a second software application; and providing, at the client device, access to at least the second data record associated with the second software application.

Example 14: The method of example 13, wherein the access to at least the second data record is provided by displaying, at the client device, the second data record.

Example 15: The method of any one of examples 13 to 14, wherein the access to at least the second data record is provided by providing a link to access the second data record through the second software application.

Example 16: The method of any one of examples 13 to 15, wherein the access to at least the second data record is provided through one or more application programming interface (API) calls to identify and/or retrieve the second data record from the second software application.

Example 17: The method of any one of examples 13 to 16, further comprising: generating, for display as an overlay on top of a user interface associated with the first software application, a user interface element for performing an action on the first data record at the second software application, the action comprising editing the first data record at the second software application, and one or more changes made to the first data record through the first software application being replicated to the second data record at the second software application in response to a selection of the user interface element.

Example 18: The method of any one of examples 13 to 17, wherein the client device includes a plug-in configured to detect the one or more interactions with the first data record.

Example 19: The method of example 18, wherein the plug-in determines the one or more identifiers associated with the first data record by at least parsing a current universal resource locator (URL) of an active window and/or tab of the browser.

Example 20: A non-transitory computer readable medium storing instructions, which when executed by at least one data processor, result in operations comprising: detecting, at a client device, one or more interactions with a first data record associated with a first software application; determining one or more identifiers associated with the first data record; identifying, based at least on the one or more identifiers, at least a second data record associated with a second software application; and providing, at the client device, access to at least the second data record associated with the second software application.

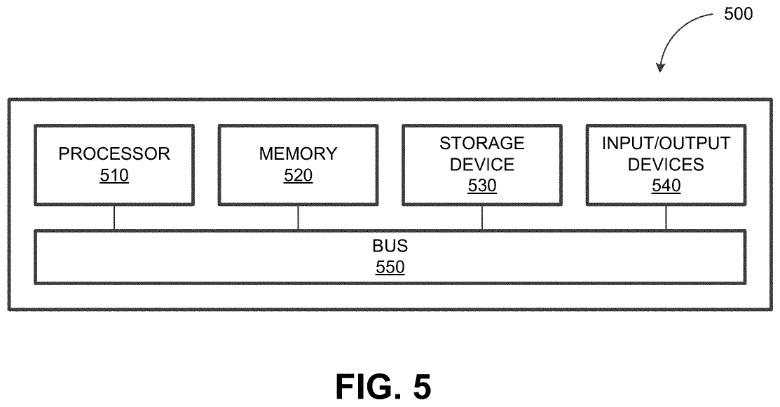

FIG. 5 depicts a block diagram illustrating a computing system 500, in accordance with some example embodiments. Referring to FIGS. 1-5, the computing system 500 can be used to implement the lifecycle management controller 110 and/or any components therein.

As shown in FIG. 5, the computing system 500 can include a processor 510, a memory 520, a storage device 530, and an input/output device 540. The processor 510, the memory 520, the storage device 530, and the input/output device 540 can be interconnected via a system bus 550. The processor 510 is capable of processing instructions for execution within the computing system 500. Such executed instructions can implement one or more components of, for example, the lifecycle management controller 110. In some implementations of the current subject matter, the processor 510 can be a single-threaded processor. Alternately, the processor 510 can be a multi-threaded processor. The processor 510 is capable of processing instructions stored in the memory 520 and/or on the storage device 530 to display graphical information for a user interface provided via the input/output device 540.

The memory 520 is a computer readable medium such as volatile or non-volatile that stores information within the computing system 500. The memory 520 can store data structures representing configuration object databases, for example. The storage device 530 is capable of providing persistent storage for the computing system 500. The storage device 530 can be a floppy disk device, a hard disk device, an optical disk device, or a tape device, or other suitable persistent storage means. The input/output device 540 provides input/output operations for the computing system 500. In some implementations of the current subject matter, the input/output device 540 includes a keyboard and/or pointing device. In various implementations, the input/output device 540 includes a display unit for displaying graphical user interfaces.

According to some implementations of the current subject matter, the input/output device 540 can provide input/output operations for a network device. For example, the input/output device 540 can include Ethernet ports or other networking ports to communicate with one or more wired and/or wireless networks (e.g., a local area network (LAN), a wide area network (WAN), the Internet).

In some implementations of the current subject matter, the computing system 500 can be used to execute various interactive computer software applications that can be used for organization, analysis and/or storage of data in various (e.g., tabular) format (e.g., Microsoft Excel®, and/or any other type of software). Alternatively, the computing system 500 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities or can be standalone computing products and/or functionalities. Upon activation within the applications, the functionalities can be used to generate the user interface provided via the input/output device 540. The user interface can be generated and presented to a user by the computing system 500 (e.g., on a computer screen monitor, etc.).

One or more aspects or features of the subject matter described herein can be realized in digital electronic circuitry, integrated circuitry, specially designed ASICs, field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. For example, the logic flows may include different and/or additional operations than shown without departing from the scope of the present disclosure. One or more operations of the logic flows may be repeated and/or omitted without departing from the scope of the present disclosure. Other implementations may be within the scope of the following claims.

What is claimed is:

1. A system, comprising:
at least one processor; and
at least one memory including program code which when executed by the at least one processor provides operations comprising:
detecting, at a client device, one or more interactions with a first data record associated with a first software application;
determining one or more identifiers associated with the first data record;
identifying, based at least on the one or more identifiers, at least a second data record associated with a second software application; and
providing, at the client device, access to at least the second data record associated with the second software application.

2. The system of claim 1, wherein the access to at least the second data record is provided by displaying, at the client device, the second data record.

3. The system of claim 1, wherein the access to at least the second data record is provided by providing a link to access the second data record through the second software application.

4. The system of claim 1, wherein the access to at least the second data record is provided through one or more application programming interface (API) calls to identify and/or retrieve the second data record from the second software application.

5. The system of claim 1, wherein the operations further comprise:
generating, for display as an overlay on top of a user interface associated with the first software application, a user interface element for performing an action on the first data record at the second software application.

6. The system of claim 5, wherein the action comprises editing the first data record at the second software application, and wherein in response to a selection of the user interface element, one or more changes made to the first data record through the first software application are replicated to the second data record at the second software application.

7. The system of claim 1, wherein the client device includes a plug-in configured to detect the one or more interactions with the first data record.

8. The system of claim 7, wherein the plug-in determines the one or more identifiers associated with the first data record by at least parsing a current universal resource locator (URL) of an active window and/or tab of the browser.

9. The system of claim 7, wherein the plug-in comprises a software add-on to a browser at the client device, and wherein the first software application and the second software application comprise cloud-based applications and/or web-based applications accessible through the browser at the client device.

10. The system of claim 1, wherein the access to at least the second data record is provided upon performing an authentication of a user at the client device.

11. The system of claim 1, wherein the one or more identifiers comprise a customer identifier and/or an account identifier.

12. The system of claim 1, wherein the first software application and the second software application comprise one or more of an enterprise resource planning (ERP) application, a customer relationship management (CRM) application, a process management application, a process intelligence application, a sales engagement application, a territory and quota management application, an agent performance management (APM) application, a social networking application, or a data warehousing application.

13. A computer-implemented method, comprising:
detecting, at a client device, one or more interactions with a first data record associated with a first software application;
determining one or more identifiers associated with the first data record;
identifying, based at least on the one or more identifiers, at least a second data record associated with a second software application;
providing, at the client device, access to at least the second data record associated with the second software application.

14. The method of claim 13, wherein the access to at least the second data record is provided by displaying, at the client device, the second data record.

15. The method of claim 13, wherein the access to at least the second data record is provided by providing a link to access the second data record through the second software application.

16. The method of claim 13, wherein the access to at least the second data record is provided through one or more application programming interface (API) calls to identify and/or retrieve the second data record from the second software application.

17. The method of claim 13, further comprising:
generating, for display as an overlay on top of a user interface associated with the first software application, a user interface element for performing an action on the first data record at the second software application, the action comprising editing the first data record at the second software application, and one or more changes made to the first data record through the first software application being replicated to the second data record at the second software application in response to a selection of the user interface element.

18. The method of claim 13, wherein the client device includes a plug-in configured to detect the one or more interactions with the first data record.

19. The system of claim 7, wherein the plug-in determines the one or more identifiers associated with the first data record by at least parsing a current universal resource locator (URL) of an active window and/or tab of the browser.

20. A non-transitory computer readable medium storing instructions, which when executed by at least one data processor, result in operations comprising:
detecting, at a client device, one or more interactions with a first data record associated with a first software application;
determining one or more identifiers associated with the first data record;
identifying, based at least on the one or more identifiers, at least a second data record associated with a second software application;
providing, at the client device, access to at least the second data record associated with the second software application.
